(19) United States
(12) Patent Application Publication
(10) Pub. No.: US 2018/0239422 A1
(43) Pub. Date: Aug. 23, 2018

(54) TRACKING EYE MOVEMENTS WITH A SMART DEVICE

(71) Applicant: INTERNATIONAL BUSINESS MACHINES CORPORATION, ARMONK, NY (US)

(72) Inventors: Brian S. Beaman, Apex, NC (US); Eric V. Kline, Rochester, MN (US); Sarbajit K. Rakshit, KOLKATA (IN)

(21) Appl. No.: 15/435,960

(22) Filed: Feb. 17, 2017

(51) Int. Cl. G06F 3/01; G06F 3/0488; G02B 27/00; G02B 27/01

(52) U.S. Cl. CPC G06F 3/013; G06F 3/04886; G02B 27/0093; G02B 27/017; G02B 2027/014; G02B 2027/0178; G02B 2027/0138; G02B 2027/0132; G02B 2027/0141; G06F 2203/04804

(57) ABSTRACT

A method and system for eye tracking according to one or more embodiment is presented. Aspects include overlaying, on a display of an ocular device, an image comprising an inner transparent region and an outer semitransparent region. Aspects also include overlaying one or more characters within the outer semitransparent region and tracking, by a sensor, an eye movement of the user to obtain a user emphasis of the one or more characters within the outer semitransparent region. Aspects also include receiving an input from the user to indicate the selection of the one or more characters based on the user emphasis.

### BACKGROUND

The present invention is related to a method and system for tracking eye movements and more particularly to a language and library employing eye movements with a smart device.

Eye tracking, which utilizes cameras and sensors to track eye movement, provides a means for individuals with severe disabilities to provide input into a technology system. For example, television devices and computer device can receive an input from a disabled user through the use of eye tracking so that the user may enjoy functionality that they may otherwise be unable to utilize.

Additionally, clandestine use of technological inputs can be effectuated by eye tracking to avoid notifying individuals of a user's manipulation of a technological input. For example, sending messages to another individual in a classroom setting can be made through eye tracking to input messages through a smart device.

### SUMMARY

Embodiments include a computer-implemented method for eye tracking, the method including overlaying, on a display of an ocular device, an image comprising an inner transparent region and an outer semitransparent region. The method also includes overlaying one or more characters within the outer semitransparent region and tracking, by a sensor, an eye movement of the user to obtain a user emphasis of the one or more characters within the outer semitransparent region. The method then includes receiving an input from the user to indicate the selection of the one or more characters based on the user emphasis.

Embodiments include a wearable eye tracking system, the system including an ocular device that includes a sensor circuit for tracking eye movement of a user and a wireless node for transmitting an eye tracking data to a secondary device. The system includes a display, wherein an image is overlaid on the display, the image comprises: an inner transparent region and an outer semitransparent region and one or more characters overlaid within the outer semitransparent region and wherein the sensor circuit is operable to track an eye movement of the user to obtain a user emphasis of the one or more characters and wherein the sensor circuit is operable to receive an input from the user to indicate the selection of the one or more characters based on the user emphasis.

Embodiments also include a computer program product for eye tracking, the computer program product including a non-transitory computer readable storage medium having computer readable program code embodied therewith. The computer readable program code including computer readable program code configured to perform a method. The method includes overlaying, on a display of an ocular device, an image comprising an inner transparent region and an outer semitransparent region. The method also includes overlaying one or more characters within the outer semitransparent region and tracking, by a sensor, an eye movement of the user to obtain a user emphasis of the one or more characters within the outer semitransparent region. The method then includes receiving an input from the user to indicate the selection of the one or more characters based on the user emphasis.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 illustrates a block diagram of a computer system for use in practicing the teachings herein;

FIG. 4 depicts a block diagram of a system for eye tracking according to one or more embodiments;

FIG. 5 depicts a value map on a display of an ocular device according to one or more embodiments;

FIG. 6 depicts a value map on a display of an ocular device according to another embodiment; and

FIG. 7 depicts a block diagram of a method for eye tracking according to one or more embodiments.

### DETAILED DESCRIPTION

In accordance with exemplary embodiments of the disclosure, methods, systems and computer program products for eye tracking are provided. Aspects include overlaying an image of a value map on the display of an ocular device. The image including an inner and outer region that has a varying degree of transparency. Between these two regions is a set of symbols or characters, such as, letters, numbers, words, and commands. The ocular device includes a sensor that tracks a user's eye movement and determines where on this value map, a user is gazing to determine a character or symbol the user is attempting to identify. Based on this eye tracking emphasis, another input can be taken to select the character, symbol or command. The type of input could be a blinking pattern of the user or an input from a secondary device that is in electronic communication with the ocular device of the user. Once a set of characters or commands is selected, the resulting string or command can be transmitted via the ocular device or through the secondary device to a third party.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

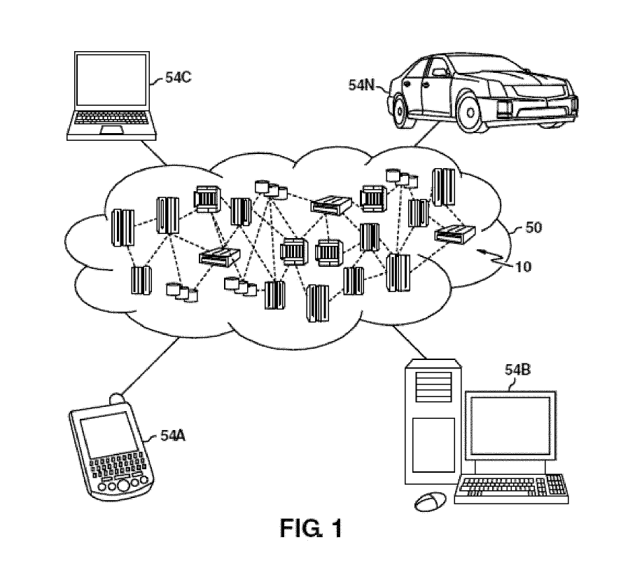

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

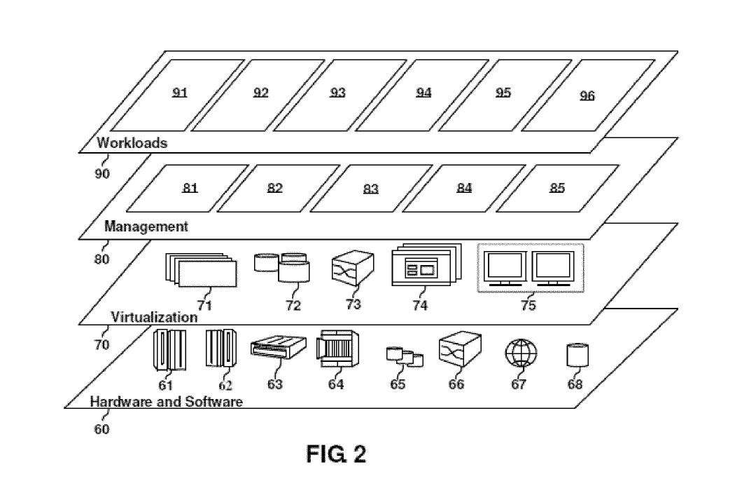

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workload layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and eye tracking 96.

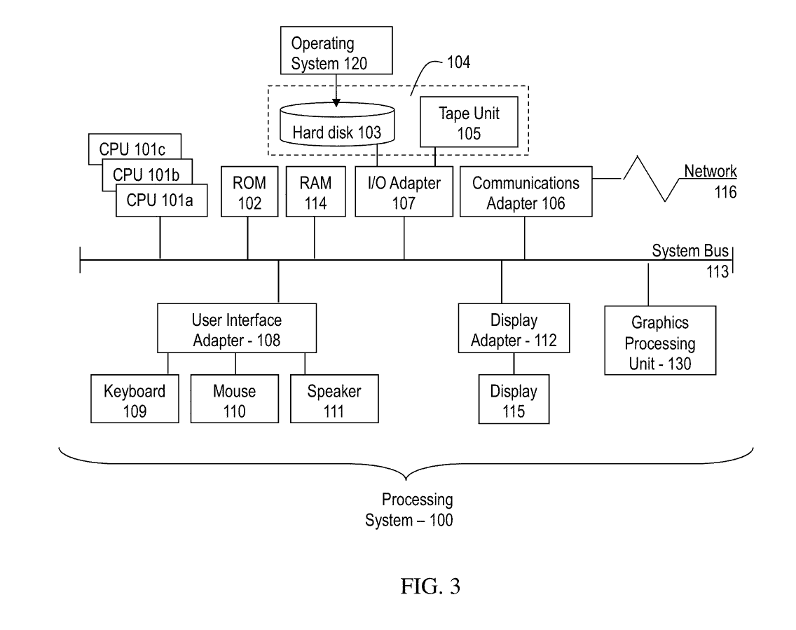

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one or more embodiments, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 3.

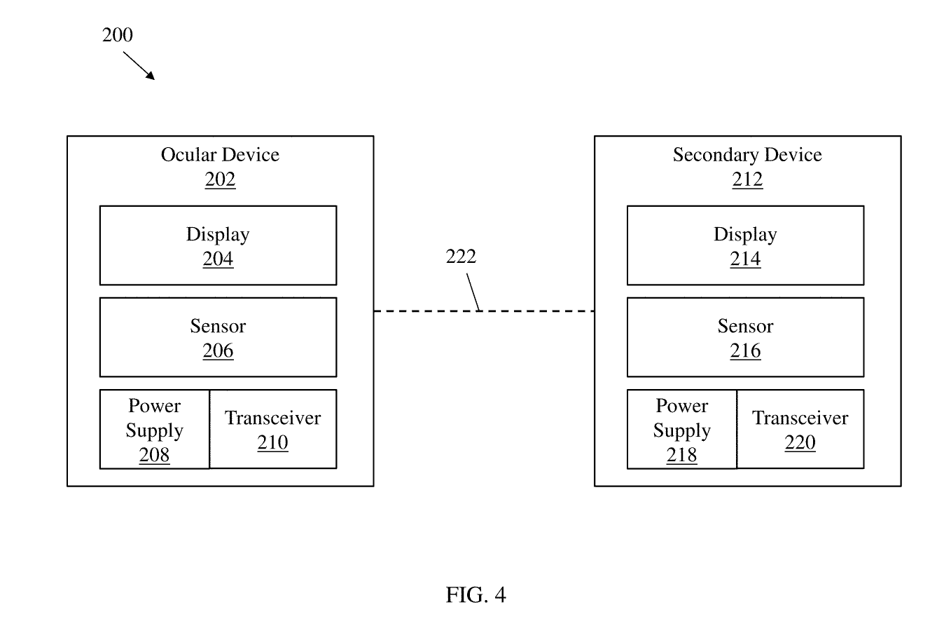

FIG. 4 depicts a block diagram of a system for eye tracking according to one or more embodiments. The system 200 includes an ocular device 202 and a secondary device 212. The ocular device 202 can be communicatively coupleable to the secondary device 212 via a link 222.

The ocular device 202 includes a display 204, a sensor 206, a power supply 208 and a transceiver 210. In the illustrated example, one sensor 206 is shown; however, in one or more embodiments, multiple sensors can be included with the ocular device 202. The secondary device 212 includes a display 214, a sensor 216, a power supply 218, and a transceiver 220. In one or more embodiments, the secondary device 212 can be a smart device such as a smart phone, laptop, or smart watch that is in electronic communication with the ocular device 202 via a link 222. In one or more embodiments, the link 222 can be any type of electronic link such as, for example, a Bluetooth® connection, an optical link, a radio frequency (RF) link, a near-field communication (NFC) link, a wireless network link, and the like. In one or more embodiments, the ocular device 202 can be powered by rectifying an RF signal. The ocular device 202 can include one or more rectification circuits that are powered by an RF signal from the secondary device 212 or from another device.

In an embodiment, the ocular device 202 can be in the form of eye glasses. Accordingly, the ocular device 202 can be secured to a user's head with two arms curved at each end to form ear hooks as is normal with eye glasses. In another embodiment, the ocular device 202 can be in the form of contact lenses.

The display 204 for the ocular device 202 can be one or more lenses for a pair of eye glasses or a contact lens or lenses. The display 204 can have images present on the display so that the lens of the eye glasses act as the display. In another embodiment, the display 204 can be a visual projection of images seen through the lenses of the eye glasses or contact lenses such that the display 204 can appear as a three-dimensional image projected beyond the location of the lens itself utilizing various visual effects.

In one or more embodiment, the ocular device 202 may not display the value map 302. Instead, a value map could be memorized by a user of the ocular device 202 and the ocular device 202 would still track eye movement and map the eye movement to the memorized value map. Because the user would not have a displayed value map to use for visual targeting during the user's eye movements, in some embodiments, the angular increments could be limited to 45 degrees. This memorized value map could include angular eye movements along with eye lid positions to determine the focus of a user's gaze along the memorized value map. The memorized value map could be based on a single eye movement or a combination of eye movements separated by blinking to determine selection of a value along the memorized value map.

The sensor 206 for the ocular device can be a camera operable to track eye movement from a user of the ocular device 202. In addition to tracking eye movement, the sensor 206 can receive other eye data such as an extended focus of gaze over a period of time, one or more blinking patterns, an extended blink or the closing of a user' s eye, and any other eye movement patterns.

In another embodiment, the sensor 206 can be a pressure sensor that can track the movement of a user's eye based on changes in the pressure on a lens surface. For example, for an ocular device 202 being a set of contact lenses, the pressure sensor can track a user's movement as the focus of a user's gaze changes with the contact lens. The pressure sensor can be a transparent capacitor or resistor matrix pressure sensor at the lens of the contact lenses. Accordingly, the transparent capacitor matrix pressure sensor can detect deformation and pressure, for example.

The ocular device 202 includes a power supply 208 and a transceiver 210. The transceiver 210 can transmit and receive data to and from the secondary device 212 via the link 222. The power supply 208 can be any battery operated power source, a piezoelectric circuit, a circuit capable of rectifying an RF signal, or any other suitable power source. The secondary device 212 includes a display 214, one or more sensors 216, a power supply 218, and a transceiver 220. The transceiver 220 can transmit and receive data to and from the ocular device 202. The display 214 can mirror the images on the display 204 for the ocular device 202 or can have a different set of images on the display 214. The sensor 216 for the secondary device 212 can track the movement of a user's hand or receive inputs from a user via a user touching the display screen or any pre-defined or user-defined hand movements.

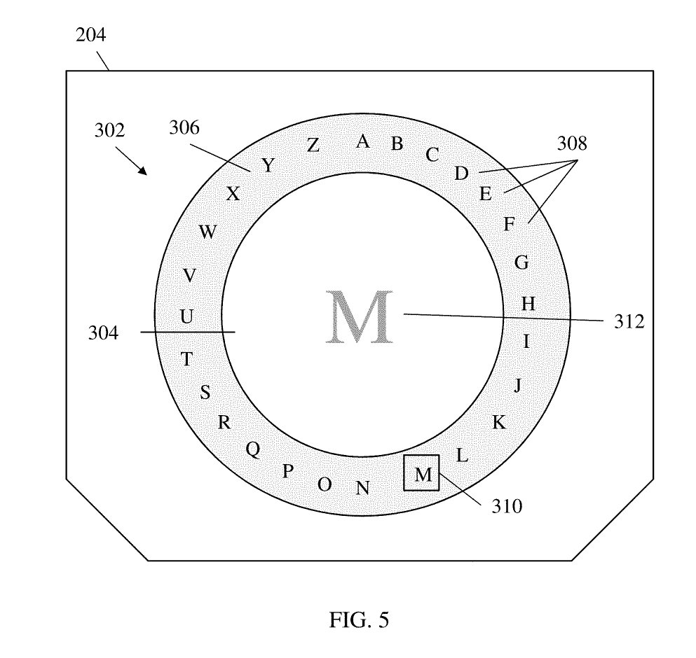

FIG. 5 illustrates a value map on the display of an ocular device in accordance with one or more embodiments. The value map 302 includes an inner region 304 and an outer region 306. The inner region 304 is transparent and the outer region 306 is semitransparent (translucent). Between the inner region 304 and the outer region 306 is a set of characters (symbols) 308 displayed in a three hundred and sixty-five degree reference frame. The illustrated example shows the set of characters 308 as letters; however, in one or more embodiments, the characters 308 can be any combination of words, numbers, letters, commands, and the like.

The characters 308 can be emphasized 310 by a user based upon a user input. The illustrated example shows a box around a character as an emphasis 310; however, in one or more embodiments, the user emphasis 310 can include an increase in character size, a change to the color or transparency of the character, an underlining of the character, a change to the background surrounding the character, and the like. In an embodiment, the emphasized character 310 can be displayed in the inner region 304 in a larger display 312 to show that particular character as being emphasized. The user input that can emphasize 310 a character 308 can be based on the tracking of a user's eye movement to emphasize 310 a character 308. The emphasis can be based on an extended gaze at a particular character for a pre-set or user-defined time period. In another embodiment, the user input can be taken from the secondary device 212. The sensor 216 can be any type of sensor including a motion tracking or touch screen sensor for the secondary device 212. A user can input hand movements for the sensor 216 to emphasize a character 308.

After a character has been emphasized 310, the user may select the character based upon a user input. The user input can be a blink of an eye by the user or a designated blinking pattern such as, for example, a double blink within a set amount of time or an extended blink for a period of time. Additional user inputs can include an extended gaze by the user or a manual input to the secondary device 212 for the selection of a character.

In one or more embodiments, the system 200 can remove characters 308 from the value map 302 as certain characters are selected by a user. For example, a user may select a letter or set of letters for a string and the system 200 may recognize available or suggested next letters for selection based on previous string selections by a user. If a user is noted for selecting “Ok” in response to a received message, the system 200 may recognize this and after the selection of the character ‘O’, the character ‘K’ could be moved closer or the other characters could be removed leaving only ‘K’ as suggested string.

In one or more embodiments, the value map 302 can display an incoming message received either at the ocular device 202 or at the secondary device 212 and transmitted to the ocular device 202. The incoming message can be displayed around all or a portion of the three hundred and sixty-degree orientation of the value map 302 between the inner region 304 and the outer region 306. In one or more embodiments, the value map 302 may be less than a three hundred and sixty-degree orientation, such as, for example, a two hundred and seventy-degree orientation.

According to an embodiment of the present invention, the secondary device 212 is a smartphone and the communication with the ocular device 202 can be via a phone application installed on the smartphone that can transmit or receive commands to and from the ocular device 202.

In one or more embodiments, the ocular device can be an eyewear. The eyewear can include cameras arranged on each lens of the eyewear to capture images of both eyes and track eye movement for each eye of the user. While the illustrated example shows only one display 204; one or more embodiments can include a value map 302 for each eye arranged on each lens of the ocular device 202. Tracking both eyes via the sensor or sensors 206 can assist with error correction when attempting to determine a user emphasis or a user selection of a character. The system 200 can be trainable for a specific user. For example, the movement of the emphasis 310 can be increased or decreased in terms of the sensitivity of the eye movement of the user.

In one or more embodiments, the sensor 206 can include, but is not limited to, an axis accelerometer, an inter-digital capacitor sensor and a wireless node. An accelerometer can detect any acceleration which includes movement. The accelerometer used for the sensor can be an accelerometer for movement detection; movement detection includes head movement or movement surrounding the eyes. These head movements can be utilized as additional inputs from the user to indicate a selection of a character or the issuance of a command to the ocular device 202.

According to another embodiment of the present invention, data collected by the sensor 206 of the ocular device 202 can be stored on the secondary device 212 so that an analysis can run on the secondary device 212. The secondary device 212 can be a personal computer or a cloud computing service or any other suitable device.

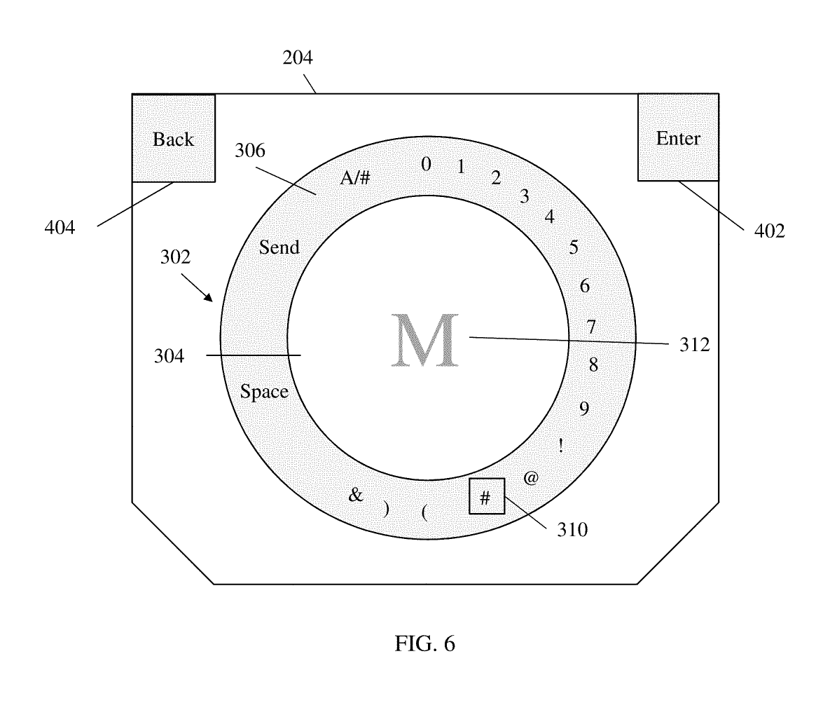

FIG. 6 illustrates a display of an ocular device according to another embodiment of the present invention. The display 204 includes one or more secondary semitransparent regions 402, 404 that are outside the outer semitransparent region 306 that can contain additional symbols, characters, text, words, and commands. In the illustrated example, the secondary regions include the commands for “enter” and “back” which indicates that a string or selection by the user can either be submitted or if there is an error can go back one or more characters for re-selection by a user. In the illustrated example, numeric characters and commands are represented on the value map 302. In one or more embodiments, any combination of letters, numbers, words, commands, and/or spaces can be utilized.

In one or more embodiments, either within the value map 302 or within the one or more secondary semitransparent regions 402, 404, a control area can be located. The control area can include commands such as toggle characters or for setup purposes. For example, the control area can allow for a user to switch from the alphabet to numbers. Another example would allow for the control area to set preferences such as transparency and size and location of the value map 302.

In one or more embodiments, the control area can be a number of degrees (e.g. 30 degrees) out of the value map 302 area as it relates to the characters so that these characters values and control areas (i.e. commands) are differentiated. In another embodiment, the different characters and commands can be located within one or more concentric rings for the value map 302. For example, a first ring could contain characters 308 for selection and a second ring made from a larger (or smaller) transparent region could be overlaid on the display to show separate ring layers for the value map 302 which could contain commands or other types of characters. These additional rings for the value map 302 can have characters and commands arranged on the value map in a three hundred and sixty five degree arrangement or any other degree of arrangement such as two hundred and seventy degrees.

In an embodiment, small and barely visible markings could be situated positional in the 360-degree reference frame corresponding to fixed locations for ‘values’ (e.g. letters, numbers, words, commands, etc.). Employing substantially transparent conductors as emitters, the characters can be electrically (programmably) excited (formed) in each cell (region) according to the current user control state (i.e., alpha characters). The user can then change from one default value to another employing the user command capability. The user can customize each cell by assigning user selected value for each cell and saving these as custom values.

In one or more embodiments, the value map 302 can be adjusted in terms of size, position, opacity, transparency, and orientation for a user preference. For example, a user may prefer a larger region between the inner transparent region 304 and the outer semitransparent region 306. Additionally, a user may change the orientation of the characters within the inner and outer region to assist with selection of the characters. For example, a user may wish to have common characters next to other common characters for ease of selection. Additionally, certain uncommon characters could be removed entirely from between the inner and outer region and selection of the uncommon characters may be made via a user input or emphasis of the one or more secondary semitransparent regions 402, 404.

A user can change the ocular device's 202 value map 302 (e.g., from alpha characters to numbers, or numbers to words, etc.). Additionally, the user can program the ocular device's 202 value map 302 to a custom definition (e.g., custom letters, numbers, words, operations) since the interpretation of a user's instructions/communications can be processed on the secondary device 212. In another embodiment, any alphabet, any numbering system, and library of terms/words can be utilized including customer characters and symbols defined by the user.

In one embodiment, a user emphasizes a character (symbol) by first initiating a command for opening communications. Then the character is selected by moving the eyes to the position of the character in the 360-degree value map 302. Then moving the eyes to a position to emphasize the character and blinking. The ‘select’ position could be fixed or variable based on a user's programming. The blinking could be a short or long blink or a plurality of blinks. To delete or backspace or put a space between values or strings of values other fixed or variable ‘delete’, ‘space’, or other operational positions can be defined as well as positions with different blink patterns for different operations.

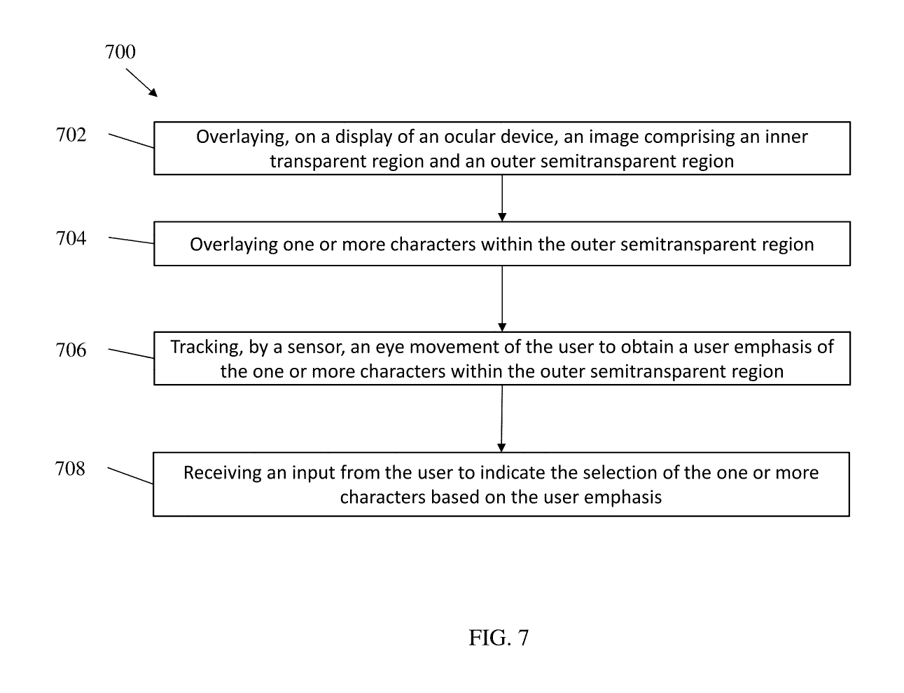

FIG. 7 illustrates a block diagram of a method for eye tracking according to one or more embodiments. The method 700 includes overlaying, on a display of an ocular device, an image comprising an inner transparent region and an outer semitransparent region, as shown at block 702. Next, at block 704, the method 700 includes overlaying one or more characters within the outer semitransparent region. At block 706, the method 700 includes tracking, by a sensor, an eye movement of the user to obtain a user emphasis of the one or more characters within the outer semitransparent region. And at block 708, the method 700 includes receiving an input from the user to indicate the selection of the one or more characters based on the user emphasis

Additional processes may also be included. It should be understood that the processes depicted in FIG. 7 represent illustrations, and that other processes may be added or existing processes may be removed, modified, or rearranged without departing from the scope and spirit of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for eye tracking comprising:
overlaying, on a display of an ocular device, an image comprising an inner transparent region and an outer semitransparent region;
overlaying one or more characters within the outer semitransparent region;
tracking, by a sensor, an eye movement of a user to obtain a user emphasis of the one or more characters within the outer semitransparent region; and
receiving an input from the user to indicate a selection of the one or more characters based on the user emphasis.

2. The method of claim 1, wherein the ocular device is a pair of eyeglasses and the sensor is a camera arranged on the pair of eyeglasses.

3. The method of claim 2, wherein the display is at least one lens on the pair of eyeglasses.

4. The method of claim 2, wherein the display is both lenses on the pair of eyeglasses.

5. The method of claim 1, wherein the input from the user comprises at least one of a blinking of an eye by the user, a continued user emphasis over a period of time, and an input from a secondary device in electronic communication with the ocular device.

6. The method of claim 1, wherein the inner transparent region is circular.

7. The method of claim 6, wherein the outer semitransparent region is circular.

8. The method of claim 7, wherein the one or more characters are overlaid within the outer semitransparent region in a three hundred and sixty degree arrangement.

9. The method of claim 1, wherein the one or more characters comprise at least one of an alphabet letter, a number, a word, and a command.

10. The method of claim 1, further comprising:
overlaying, on the display, one or more secondary semitransparent regions outside the outer semitransparent region; and
overlaying one or more characters within the one or more secondary semitransparent regions.

11. A wearable eye tracking system comprising:
an ocular device comprising:
a sensor circuit for tracking eye movement of a user;
a wireless node for transmitting an eye tracking data to a secondary device;
a display, wherein an image is overlaid on the display, the image comprises: an inner transparent region and an outer semitransparent region and one or more characters overlaid within the outer semitransparent region;
wherein the sensor circuit is operable to track an eye movement of the user to obtain a user emphasis of the one or more characters; and
wherein the sensor circuit is operable to receive an input from the user to indicate a selection of the one or more characters based on the user emphasis.

12. The system of claim 11, wherein the inner transparent region is circular;
wherein the outer semitransparent region is circular; and
wherein the one or more characters are overlaid within the outer semitransparent region in a three hundred and sixty degree arrangement.

13. The system of claim 11, wherein the display is further overlaid with one or more secondary semitransparent regions outside the outer semitransparent region; and
one or more characters within the one or more secondary semitransparent regions.

14. A computer program product for eye tracking, the computer program product comprising a computer readable storage medium having program instructions embodied therewith, the program instructions executable by a processor to cause the processor to perform:
overlaying, on a display of an ocular device, an image comprising an inner transparent region and an outer semitransparent region;
overlaying one or more characters within the outer semitransparent region;
tracking, by a sensor, an eye movement of a user to obtain a user emphasis of the one or more characters within the outer semitransparent region; and
receiving an input from the user to indicate a selection of the one or more characters based on the user emphasis.

15. The computer program product of claim 14, wherein the ocular device is a pair of eyeglasses and the sensor is a camera arranged on the pair of eyeglasses.

16. The computer program product of claim 15, wherein the display is at least one lens on the pair of eyeglasses.

17. The computer program product of claim 15, wherein the display is both lenses on the pair of eyeglasses.

18. The computer program product of claim 14, wherein the inner transparent region is circular.

19. The computer program product of claim 18, wherein the outer semitransparent region is circular.

20. The computer program product of claim 19, wherein the one or more characters are overlaid within the outer semitransparent region in a three hundred and sixty degree arrangement.
